(19) United States
(12) Patent Application Publication
(10) Pub. No.: US 2026/0177460 A1
(43) Pub. Date: Jun. 25, 2026

(54) ELECTRONIC APPARATUS AND CONTROLLING METHOD THEREOF

(71) Applicant: Samsung Electronics Co., Ltd., Suwon-si (KR)

(72) Inventors: Minkyung KIM, Suwon-si (KR); Seungeun CHUNG, Suwon-si (KR); Seungwan YOO, Suwon-si (KR); Sanghoon BAEK, Suwon-si (KR); Dokyeong KIM, Suwon-si (KR); Dongho KEUM, Suwon-si (KR)

(21) Appl. No.: 19/416,837

(22) Filed: Dec. 11, 2025

Related U.S. Application Data
(63) Continuation of application No. PCT/KR2025/015697, filed on Oct. 1, 2025.

(30) Foreign Application Priority Data
Dec. 20, 2024 (KR) 10-2024-0192374

(51) Int. Cl. G01M 99/00; D06F 58/38; D06F 58/50; D06F 103/04; D06F 103/08; D06F 103/32; G01K 3/00

(52) U.S. Cl. CPC G01M 99/005; D06F 58/38; D06F 58/50; G01K 3/005; D06F 2103/04; D06F 2103/08; D06F 2103/32

(57) ABSTRACT

Provided is an electronic apparatus including: a communication interface; a memory storing instructions; and at least one processor, wherein, if collectively or individually executed by the at least one processor, the instructions cause the electronic apparatus to identify at least one of a plurality of data received from a dryer, including information about a drying operation time of the dryer, information about an outlet temperature of a compressor included in the dryer, information about a weight of laundry to be dried or information about an internal temperature of a drum, and obtain information about an error state of the dryer based on the identified information.

### CROSS-REFERENCE TO RELATED APPLICATIONS

This application is a continuation of International Application No. PCT/KR2025/015697 designating the United States, filed on Oct. 1, 2025, in the Korean Intellectual Property Receiving Office and claiming priority to Korean Patent Application No. 10-2024-0192374, filed on Dec. 20, 2024, in the Korean Intellectual Property Office, the disclosures of each of which are incorporated by reference herein in their entireties.

### BACKGROUND

### Field

The disclosure relates to an electronic apparatus and a controlling method thereof, and for example, to an electronic apparatus for obtaining information about a dryer and identifying information about a state of the dryer, and a controlling method thereof.

### Description of Related Art

A dryer may predict a drying time based on a measured weight of laundry to be dried and perform drying.

However, it is difficult for a user to recognize problems occurring during a drying process performed by the dryer.

Therefore, a need has arisen for a method for receiving the information about the dryer from a server device, then predicting the problems occurring in the dryer based thereon, and to provide guidance to the user.

### SUMMARY

According to an example embodiment of the present disclosure, provided is an electronic apparatus including: a communication interface comprising communication circuitry; a memory storing instructions; and at least one processor, comprising processing circuitry, wherein, at least one processor, collectively or individually is configured to execute the instructions and to cause the electronic apparatus to: identify at least one of a plurality of data received from a dryer, such as information about a drying operation time of the dryer, information about an outlet temperature of a compressor included in the dryer, information about a weight of laundry to be dried and/or information about an internal temperature of a drum, and obtain information about an error state of the dryer based on the identified information.

At least one processor, individually and/or collectively, may be configured to cause the electronic apparatus to identify that an abnormality occurs in a humidity sensor included in the dryer based on the drying operation time of the dryer being less than a specified time.

At least one processor, individually and/or collectively, may be configured to cause the electronic apparatus to: identify that the abnormality occurs in the humidity sensor included in the dryer based on the drying operation time of the dryer being greater than or equal to the specified time, and the internal temperature of the drum measured after a drying operation of the dryer is completed being greater than or equal to a specified temperature.

At least one processor, individually and/or collectively, may be configured to cause the electronic apparatus to identify that an amount of laundry to be dried is less than a specified weight based on the drying operation time of the dryer being less than the specified time, and the internal temperature of the drum included in the dryer measured after the drying operation of the dryer is completed being less than the specified temperature.

At least one processor, individually and/or collectively, may be configured to cause the electronic apparatus to include information indicating that the amount of laundry to be dried is required to be filled to the specified weight or more.

At least one processor, individually and/or collectively, may be configured to cause the electronic apparatus to identify that a flow passage included in the dryer is clogged based on a ratio of an actual drying operation time of the dryer to a predicted drying operation time of the dryer being greater than or equal to a specified value, and the temperature of the compressor included in the dryer being greater than or equal to a specified temperature.

At least one processor, individually and/or collectively, may be configured to cause the electronic apparatus to identify that an abnormality occurs in a sensor included in the dryer based on the ratio of the actual drying operation time of the dryer to the predicted drying operation time of the dryer being greater than or equal to the specified value, and a result value obtained by subtracting an actual weight value from a weight value obtained using the sensor included in the dryer being greater than or equal to a specified value.

At least one processor, individually and/or collectively, may be configured to cause the electronic apparatus to transmit the information about the error state of the dryer to an external device.

According to an example embodiment of the present disclosure, provided is a method of controlling an electronic apparatus, the method including: identifying at least one of a plurality of data received from a dryer, such as information about a drying operation time of the dryer, information about an outlet temperature of a compressor included in the dryer, information about a weight of laundry to be dried or information about an internal temperature of a drum; and obtaining information about an error state of the dryer based on the identified information.

The method may further include identifying that an abnormality occurs in a humidity sensor included in the dryer in response to the drying operation time of the dryer being less than a specified time.

The method may further include identifying that the abnormality occurs in the humidity sensor included in the dryer in response to the drying operation time of the dryer being greater than or equal to the specified time, and the internal temperature of the drum measured after a drying operation of the dryer is completed being greater than or equal to a specified temperature.

The method may further include identifying that an amount of laundry to be dried is less than a specified weight in response to the drying operation time of the dryer being less than the specified time, and the internal temperature of the drum included in the dryer measured after the drying operation of the dryer is completed being less than the specified temperature.

The method may further include including information indicating that the amount of laundry to be dried is required to be filled to the specified weight or more.

The method may further include identifying that a flow passage included in the dryer is clogged in response to a ratio of an actual drying operation time of the dryer to a predicted drying operation time of the dryer being greater than or equal to a specified value, and a temperature of the compressor included in the dryer being greater than or equal to a specified temperature.

The method may further include identifying that an abnormality occurs in a sensor included in the dryer in response to the ratio of the actual drying operation time of the dryer to the predicted drying operation time of the dryer being greater than or equal to the specified value, and a result value obtained by subtracting an actual weight value from a weight value obtained using the sensor included in the dryer being greater than or equal to a specified value.

The method may further include transmitting the information about the error state of the dryer to an external device.

According to an example embodiment of the present disclosure, provided is a non-transitory computer-readable recording medium including a program for executing a controlling method of an electronic apparatus, wherein the method includes identifying: at least one of a plurality of data received from a dryer, such as information about a drying operation time of the dryer, information about an outlet temperature of a compressor included in the dryer, information about a weight of laundry to be dried or information about an internal temperature of a drum, and obtaining information about an error state of the dryer based on the identified information.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating an example of an electronic apparatus according to various embodiments;

FIG. 2 is a block diagram illustrating an example configuration of the electronic apparatus according to various embodiments;

FIGS. 3, 4 and 5 are tables illustrating an example operation process for obtaining information about an error state of a dryer according to various embodiments;

FIG. 6 is a block diagram illustrating an example configuration of the dryer according to various embodiments; and

FIG. 7 is a flowchart illustrating an example method of controlling an electronic apparatus according to various embodiments.

### DETAILED DESCRIPTION

The present disclosure may be variously modified and have various example embodiments, and various example embodiments of the present disclosure are thus illustrated in the accompanying drawings and described in detail in this disclosure. However, it should be understood that the scope of the present disclosure are not limited, and includes all modifications, equivalents, and alternatives. Throughout the accompanying drawings, similar components are denoted by similar reference numerals.

In describing the present disclosure, a detailed description of a case where it is decided that a detailed description of the known functions or configurations related to the present disclosure may unnecessarily obscure the gist of the present disclosure may be omitted.

Terms used in the present disclosure are used to describe the various embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

If any component (for example, the first component) is mentioned to be “directly coupled with/to” or “directly connected to” another component (for example, the second component), it should be understood that yet another component (for example, the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

The expression “a device configured to”, in any context, may indicate that the device may “perform˜” together with another device or component. For example, a “processor configured (or set) to perform A, B, and C” may indicate a dedicated processor (for example, an embedded processor) that may perform the corresponding operations or a general-purpose processor (for example, a central processing unit (CPU) or an application processor) that may perform the corresponding operations by executing one or more software programs stored in a memory device.

In the various example embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by the at least one processor except for a “module” or a “part” that needs to be implemented by specific hardware.

The various elements and areas in the drawings are schematically illustrated. Therefore, the spirit of the present disclosure is not limited by relative sizes or intervals shown in the accompanying drawings.

Hereinafter, various example embodiments of the present disclosure are described in greater detail with reference to the accompanying drawings.

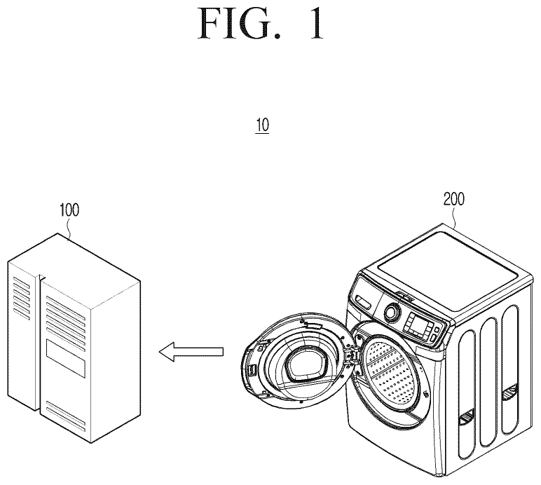

FIG. 1 is a perspective view illustrating an example system for obtaining information about an error state of a dryer using information about an operation of the dryer, according to various embodiments.

As shown in FIG. 1, the system 10 may include an electronic apparatus 100 and a dryer 200. The electronic apparatus 100 may be implemented as a server as shown in FIG. 1, which is simply an example, and may be implemented as any of various electronic apparatuses such as a tablet or a laptop.

For convenience of description, the dryer 200 is described below as a dryer that performs a drying operation, which is simply an example, and the dryer 200 may be implemented as a washing machine that also performs a drying function.

The electronic apparatus 100 may store an artificial intelligence model trained to obtain information about the operation or state of the dryer and output an error state of the dryer. However, this configuration is simply an example, and the electronic apparatus 100 may also transmit the artificial intelligence model to the dryer 200.

The electronic apparatus 100 may obtain information about the dryer 200. The obtained information about the dryer 200 may be information about a door state (for example, a closed state or an opened state), a filter state (information about a filter clogging level), a set drying mode (a standard mode or a strong mode), or user input data (information about a temperature or time setting) obtained using a sensor 250 included in the dryer 200.

However, this configuration is simply an example, and the electronic apparatus 100 may obtain information about the number of times the dryer 200 is used, information about an accumulated usage time, or information about power consumption (the current energy usage or consumption pattern of the dryer 200).

The electronic apparatus 100 may identify at least one of the plurality of obtained information, such as information about a drying operation time of the dryer 200, information about an outlet temperature of a compressor included in the dryer 200, information about a weight of laundry to be dried, or information about an internal temperature of a drum.

The electronic apparatus 100 may identify the error state of the dryer 200 based on a predetermined condition and the identified information.

For example, the electronic apparatus 100 may identify whether an abnormality occurs in a humidity sensor included in the dryer 200, whether an amount of a refrigerant is insufficient, whether an amount of laundry to be dried is extremely small, whether a flow passage is clogged, and whether a weight detection sensor requires correction.

The electronic apparatus 100 may store information about the error state of the dryer 200 and then transmit same to an external device.

Through the above operation, the electronic apparatus 100 may identify which operation of the dryer 200 or which component of the dryer 200 causes an error.

The electronic apparatus 100 may transmit error occurrence information to the dryer 200. The dryer 200 may also display a guidance user interface (UI) including text for guiding a user to take appropriate action through a display included in the dryer.

For example, the electronic apparatus 100 may identify that the amount of laundry to be dried included in the dryer is extremely small. The electronic apparatus 100 may transmit information indicating that the amount of laundry to be dried is extremely small to the dryer 200. The dryer 200 may display the guidance UI including text such as “An amount of laundry to be dried is extremely small. Please add more laundry to be dried.” on the display.

This configuration is simply an example. The electronic apparatus 100 may transmit the error occurrence information to an external user terminal device (e.g., a mobile phone or a tablet personal computer (PC)). The external user terminal device may output the error occurrence information and information guiding the user to take the appropriate action on the display.

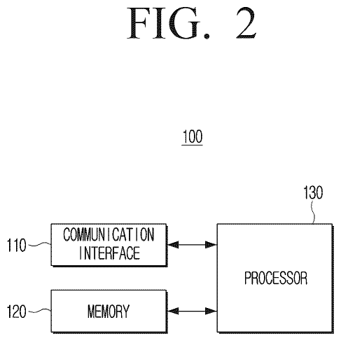

FIG. 2 is a block diagram illustrating an example configuration of the electronic apparatus 100 according to various embodiments.

The components shown in FIG. 2 are imply examples, and some components may be omitted, or a new component may be added. As shown in FIG. 2, the electronic apparatus 100 may include a communication interface (e.g., including communication circuitry) 110, a memory 120, and a processor (e.g., including processing circuitry) 130. The components shown in FIG. 2 are simply an example, and some components may be deleted or added based on a configuration of the electronic apparatus 100.

The communication interface 110 may include various communication circuitry and is a component for performing communication with various types of external devices using various types of communication methods. In particular, the communication interface 110 may receive the information about the dryer 200. The communication interface 110 may also be used to transmit the information about the error state if input data for requesting the information about the error state of the dryer 200 is input from the external device.

A wireless communication module may be a module that communicates with the external device in a wireless manner. For example, the wireless communication module may include at least one of a wireless fidelity (Wi-Fi) module, a Bluetooth module, an infrared communication module, an ultrawideband (UWB) module, or other communication modules.

A wired communication module may be a module that communicates with the external device in a wired manner. For example, the wired communication module may include at least one of a local area network (LAN) module, an Ethernet module, a pair of cables, a coaxial cable, or a fiber optic cable.

The memory 120 may store an operating system (OS) for controlling overall operations of the components included in the electronic apparatus 100 and instructions or information related to the components included in the electronic apparatus 100. In particular, the memory 120 may store the information about the dryer 200 or the information about the error state of the dryer 200.

The memory 120 may be implemented in any of various forms, such as a volatile memory (e.g., a dynamic RAM (DRAM)), a static RAM (SRAM), or a synchronous dynamic RAM (SDRAM)) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)).

The processor 130 may include at least one processor including various processing circuitry. For example, at least one processor may include at least one of a central processing unit (CPU), a graphic processing unit (GPU), an accelerated processing unit (APU), a many integrated core (MIC), a digital signal processor (DSP), a neural processing unit (NPU), a hardware accelerator, and/or a machine learning accelerator. The processor 130 may control one or any combination of other components included in the electronic apparatus, and may perform an operation related to the communication or data processing. At least one processor may execute at least one program or instruction stored in the memory. For example, at least one processor may perform a method according to an embodiment of the present disclosure by executing at least one instruction stored in the memory.

At least one processor may be implemented as a single-core processor including a single core, or may be implemented as at least one multi-core processor including multiple cores (e.g., homogeneous multiple cores or heterogeneous multiple cores). If at least one processor is implemented as the multi-core processor, each of the multiple cores included in the multi-core processor may include a processor internal memory such as a cache memory or an on-chip memory, and a common cache shared by the multiple cores may be included in the multi-core processor. In addition, each (or some) of the multiple cores included in the multi-core processor may independently read and perform a program instruction for implementing the method according to an embodiment of the present disclosure, or all (or some) of the multiple cores may be linked with each other to read and perform the program instruction for implementing the method according to an embodiment of the present disclosure. Thus, the processor 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the processor 130 may identify at least one of the plurality of data received from the dryer 200, such as the information about the drying operation time of the dryer 200, the information about the outlet temperature of the compressor included in the dryer 200, the information about the weight of laundry to be dried, or the information about an internal temperature of a drum 240, and obtain the information about the error state of the dryer 200 based on the identified information. In addition, the processor 130 may identify that the abnormality occurs in the humidity sensor 250 included in the dryer if the drying operation time of the dryer 200 is less than a predetermined time.

The processor 130 may identify that the abnormality occurs in the humidity sensor 250 included in the dryer 200 if the drying operation time of the dryer 200 is greater than or equal to the predetermined time, and the internal temperature of the drum 240 measured after the drying operation of the dryer 200 is completed is greater than or equal to a predetermined temperature.

The processor 130 may identify that the amount of laundry to be dried is less than a predetermined weight if the drying operation time of the dryer 200 is less than the predetermined time, and the internal temperature of the drum 240 included in the dryer 200 measured after the drying operation of the dryer 200 is completed is less than the predetermined temperature.

The processor 130 may obtain information indicating that the amount of laundry to be dried is required to be filled to the predetermined weight or more.

The processor 130 may identify that the flow passage included in the dryer 200 is clogged if a ratio of an actual drying operation time of the dryer 200 to a predicted drying operation time of the dryer 200 is greater than or equal to a predetermined value, and a temperature of the compressor included in the dryer is greater than or equal to a predetermined temperature. The processor 130 may identify that the abnormality occurs in the sensor 250 included in the dryer 200 if the ratio of the actual drying operation time of the dryer 200 to the predicted drying operation time of the dryer 200 is greater than or equal to the predetermined value and a result value obtained by subtracting an actual weight value from a weight value obtained using the sensor 250 included in the dryer is greater than or equal to a predetermined value. The processor 130 may transmit the information about the error state of the dryer to the external device.

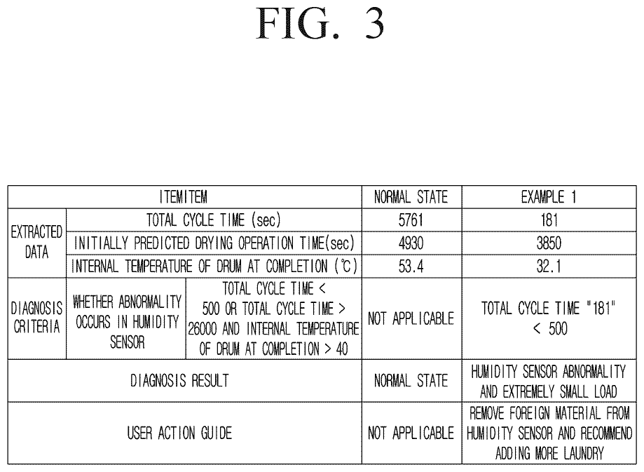

The respective operations described above are described in greater detail below with reference to FIGS. 3, 4 and 5 (which may be referred to as FIGS. 3 to 5).

FIG. 3 is a table illustrating an example method for identifying whether the abnormality occurs in the sensor 250 included in the electronic apparatus 100 or whether the amount of laundry to be dried is extremely small, according to various embodiments.

The electronic apparatus 100 may identify that the abnormality occurs in the humidity sensor 250 included in the dryer 200 if the drying operation time of the dryer 200 is less than the predetermined time.

The electronic apparatus 100 may identify that the abnormality occurs in the humidity sensor 250 included in the dryer if the drying operation time of the dryer 200 is greater than or equal to the predetermined time, and the internal temperature of the drum 240 is greater than or equal to the predetermined temperature after the drying operation of the dryer 200 is completed.

For example, the electronic apparatus 100 may be set to identify that the abnormality occurs in the humidity sensor 250 if a total drying operation time is less than 500 seconds. The electronic apparatus 100 may be set to identify that the abnormality occurs in the humidity sensor 250 if the total drying operation time is 26000 seconds or longer, and the internal temperature of the drum 240 measured after the drying operation is completed is greater than or equal to 40 degrees.

For example, as shown in FIG. 3, the electronic apparatus 100 may identify that the drying operation (or the drying operation time) of the dryer 200 lasts for 181 seconds. Here, a predetermined time for a normal drying operation time of the dryer 200 may be 500 seconds. The electronic apparatus 100 may identify that the abnormality occurs in the humidity sensor 250 if the drying operation time is 181 seconds because the drying operation time is less than 500 seconds, which is the predetermined time.

As another example, the electronic apparatus 100 may identify that the internal temperature of the drum 240 is 45 degrees if the drying operation of the dryer 200 is 26000 seconds and the drying operation is completed. The electronic apparatus 100 may identify that the abnormality occurs in the humidity sensor 250 included in the dryer 200.

As described above, the electronic apparatus 100 may identify whether the abnormality occurs in the humidity sensor 250 based on the drying operation time and the internal temperature of the drum 240.

An example embodiment is described below for identifying whether drying of laundry to be dried is not performed normally due to the extremely small amount of laundry to be dried based on the drying operation time and the internal temperature of the drum 240.

For convenience of description, the operation for identifying whether the abnormality occurs in the humidity sensor 250 and the operation for identifying the amount of laundry to be dried are described separately. However, this configuration is simply an example. The electronic apparatus 100 may simultaneously determine whether the abnormality occurs in the humidity sensor 250 and the amount of laundry to be dried corresponds to a predetermined amount based on the drying operation time and the internal temperature of the drum 240.

For example, the electronic apparatus 100 may identify that the amount of laundry to be dried is less than the predetermined weight if the drying operation time of the dryer 200 is less than the predetermined time, and the internal temperature of the drum 240 included in the dryer 200 is less than the predetermined temperature after the drying operation of the dryer 200 is completed. Here, the electronic apparatus 100 may identify that the amount of laundry to be dried is required to be filled to the predetermined weight or more.

If the dryer 200 contains the extremely small amount of laundry to be dried (for example, a small number of small clothes), the sensor 250 may not come into contact with, or may come into irregular contact with, laundry to be dried. The humidity sensor 250 may detect moisture by coming into contact with a surface of laundry to be dried. However, if the dryer 200 contains only the extremely small amount of laundry to be dried, the humidity sensor 250 may not be able to properly detect humidity due to its reduced frequency of contact with the dried laundry.

Therefore, if the dryer 200 contains the extremely small amount of laundry to be dried, the sensor 250 may not be able to accurately measure the humidity. Accordingly, the drying time may not be set accurately. Here, laundry to be dried may be over-dried if the drying time is set longer, and laundry to be dried may not be sufficiently dried if the drying time is set shorter.

The electronic apparatus 100 may identify that the amount of laundry to be dried is extremely small if the drying operation time is less than 4033 seconds and the internal temperature of the drum 240 is lower than 40 degrees upon completing the drying operation.

As shown in Example 1 in FIG. 3, if the total drying operation time is 181 seconds, less than 4033 seconds, which is the predetermined time, and the drying operation is completed, the electronic apparatus 100 may identify that the amount of laundry to be dried is extremely small because the internal temperature of the drum 240 is 32.1 degrees. Accordingly, the electronic apparatus 100 may identify that the user is required to add more laundry to be dried.

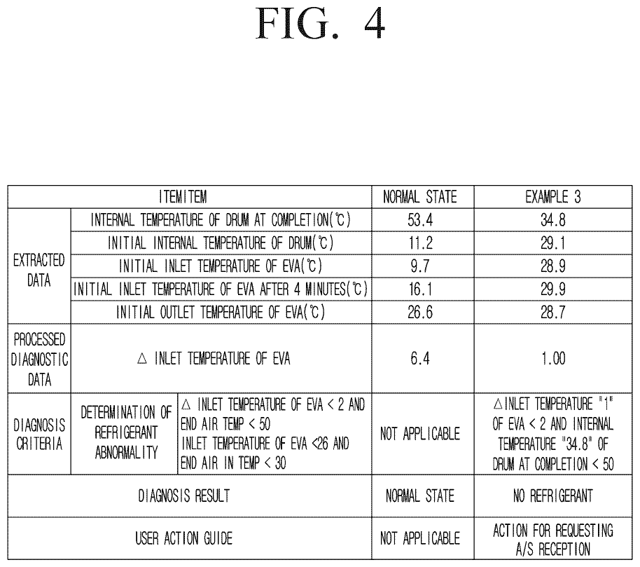

FIG. 4 is a table illustrating an example method for identifying an embodiment in which the dryer 200 has the insufficient or small amount of refrigerant according to various embodiments.

The electronic apparatus 100 may identify whether the amount of refrigerant is insufficient based on a temperature difference at an inlet of an evaporator (or Eva) included in the dryer 200 and information about the temperature of the drum 240 measured after the drying operation is completed.

The electronic apparatus 100 may obtain an inlet temperature of the evaporator measured before the drying operation starts and an inlet temperature of the evaporator measured after the drying operation is completed to identify whether the amount of refrigerant is insufficient, and obtain a difference value between the inlet temperatures of the evaporator.

For example, if the amount of refrigerant included in the dryer 200 is insufficient, the difference value between the inlet temperatures of the evaporator may be small. For example, if the amount of refrigerant in the dryer 200 is insufficient, heat exchange may not occur in the evaporator, and a heat absorption amount at the inlet or outlet of the evaporator may decrease, thus making the temperature difference value of the evaporator small.

For example, the electronic apparatus 100 may be set to identify that no refrigerant is included in the dryer if the difference between the inlet temperatures of the evaporator included in the dryer 200 (e.g., the difference value between the inlet temperature of the evaporator measured before the drying operation starts and the inlet temperature of the evaporator measured after the drying operation is completed) is less than 2 degrees, and the internal temperature of the drum 240 measured after the drying operation is completed is less than 50 degrees.

The electronic apparatus 100 may be set to identify that the amount of refrigerant is insufficient if the temperature of the evaporator included in the dryer 200 is greater than or equal to 26 degrees and the internal temperature of the drum 240 measured after the drying operation is completed is less than 30 degrees.

As shown in Example 3 in FIG. 4, the difference between the inlet temperatures of the evaporator included in the dryer 200 may be 1 degree, and the internal temperature of the drum 240 measured after the drying operation is completed may be 34.8 degrees. The difference between the inlet temperatures of the evaporator included in the dryer 200 may be less than 2 degrees, and the internal temperature of the drum 240 measured after the drying operation is completed may be less than 50 degrees. In this case, the electronic apparatus 100 may identify that no refrigerant is included in the dryer.

If it is identified that no refrigerant is included in the dryer, the electronic apparatus 100 may transmit information indicating that no refrigerant is included in the dryer to the external user terminal device (e.g., a mobile phone) or transmit information guiding the user to request after-service (A/S) because no refrigerant is included in the dryer. In addition, the user may input information for requesting A/S reception to a user terminal device because no refrigerant is included in the dryer.

However, this configuration is simply an example, and the electronic apparatus 100 may directly request the A/S reception without separately transmitting the information guiding the user to request the A/S reception to the external user terminal device.

If the dryer 200 is in a normal state, an example is possible in which the difference between the inlet temperatures of the evaporator included in the dryer 200 is “6.4” degrees, which is greater than 2 degrees, and the internal temperature of the drum 240 measured after the drying operation is completed is 53.4 degrees. The electronic apparatus 100 may identify that the amount of refrigerant contained in the dryer 200 is normal.

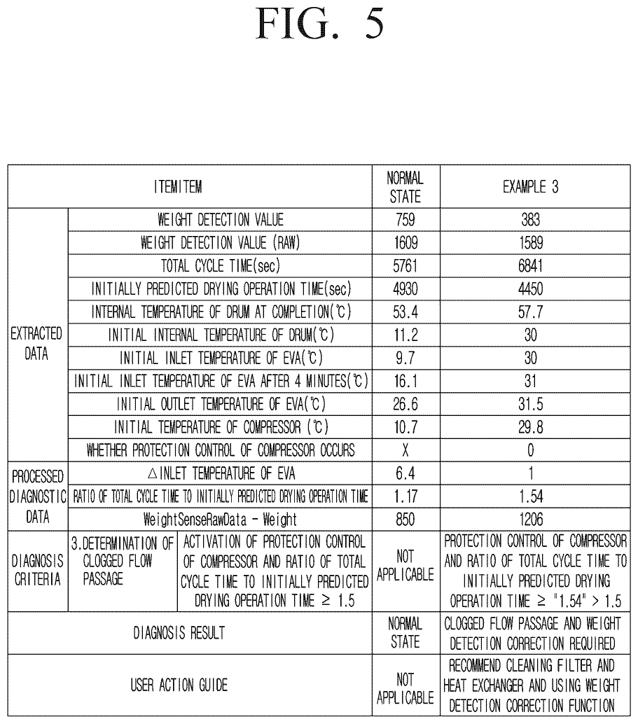

FIG. 5 is a table illustrating an example operation for identifying whether the flow passage of the dryer 200 is clogged or whether weight detection correction is required, according to various embodiments.

The electronic apparatus 100 may identify that the flow passage is clogged if a protection control of a compressor 230 occurs and a value of a ratio of the total drying operation time to an initially predicted drying operation time is greater than or equal to the predetermined value.

For example, the electronic apparatus 100 may identify that the flow passage included in the dryer is clogged if the value of the ratio of the predicted drying operation time of the dryer 200 to the initially predicted drying operation time is greater than or equal to a predetermined value and a temperature of the compressor 230 included in the dryer 200 is greater than or equal to a predetermined temperature.

As shown in FIG. 5, the electronic apparatus 100 may identify the value of the ratio of the predicted drying operation (or the drying operation time) of the dryer to the initially predicted drying operation time if the protection control of the compressor 230 occurs. The electronic apparatus 100 may identify that the flow passage is clogged if the identified value is greater than the predetermined value.

For example, the electronic apparatus 100 may identify that the compressor 230 is overheated because an airflow is restricted if the flow passage (air circulation passage) of the dryer 200 is clogged, and thus may identify whether the protection control of the compressor 230 occurs.

For example, as shown in Example 3, if it is identified that the protection control of the compressor 230 occurs, the electronic apparatus 100 may obtain the value of the ratio of the predicted drying operation (or the drying operation time) of the dryer to the initially predicted drying operation time.

The electronic apparatus 100 may be set to identify that the flow passage is clogged if the ratio of the predicted drying operation (or the drying operation time) of the dryer to the initially predicted drying operation time has a value greater than or equal to 1.5.

The electronic apparatus 100 may identify that the protection control of the compressor occurs and the ratio of the predicted drying operation (or the drying operation time) of the dryer to the initially predicted drying operation time has a value of 1.54. The electronic apparatus 100 may identify that the flow passage is clogged.

The operation for identifying whether the flow passage of the dryer 200 is clogged is described above. Hereinafter, an operation for identifying whether the dryer 200 requires the weight detection correction is described below.

For example, the electronic apparatus 100 may identify that the abnormality occurs in the weight detection sensor 250 included in the dryer 200 if the ratio of the actual drying operation time of the dryer to the predicted drying operation time of the dryer is greater than or equal to the predetermined value and the result value obtained by subtracting the actual weight value from the weight value obtained using the sensor included in the dryer is greater than or equal to the predetermined value.

The electronic apparatus 100 may identify that the weight detection sensor 250 included in the dryer 200 is not operating normally if a difference value between the weight obtained from the dryer 200 (e.g., the weight detected using the sensor 250) and the actual weight is greater than the predetermined value.

As shown in Example 3, if a value of the weight (WeightSenseRawData) obtained from the dryer 200 is 1589 and the actual weight value is 383, a difference value between the two values is 1206.

If the predetermined value is set to 1000, the electronic apparatus 100 may identify that it is required to use a weight detection correction function because the obtained value is 1206, which is more than 1000, or the abnormality occurs in the weight detection sensor 250.

If the abnormality occurs in the weight detection sensor 250, and the dryer 200 thus detects a heavier amount of laundry to be dried than the actual amount, a longer drying time may be set, resulting in a waste of energy.

If the abnormality occurs in the weight detection sensor 250, the dryer 200 thus detects a lighter amount of laundry to be dried than the actual amount, the drying operation may be completed while laundry to be dried remains undried and still wet.

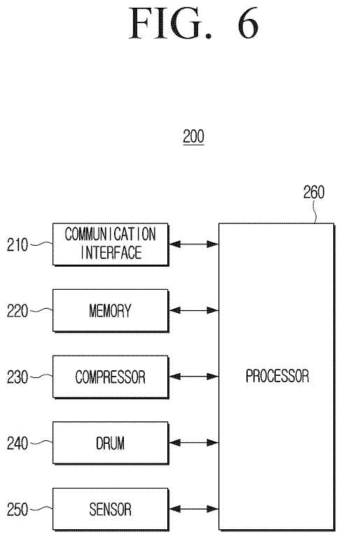

FIG. 6 is a block diagram illustrating an example configuration of the dryer according to various embodiments. The components shown in FIG. 6 are examples, and some components may be omitted, or a new component may be added.

As shown in FIG. 6, the dryer 200 may include a communication interface (e.g., including communication circuitry) 210, a memory 220, a compressor 230, the drum 240, the sensor 250, and a processor (e.g., including processing circuitry) 260.

The components shown in FIG. 6 are simply an example, and some components may be omitted or added based on a configuration of the dryer 200.

Among the components included in the dryer 200, descriptions of components overlapping with those shown in FIG. 2 among specific examples of the communication interface 210, the memory 220, and the processor 260 may not be repeated here.

The communication interface 210 may include various communication circuitry and transmit the information about the dryer 200 to the electronic apparatus 100. Here, the information about the dryer 200 is described above, and a detailed description thereof is thus omitted.

The compressor 230 may remove moisture from air. If air is suctioned in from inside the dryer 200, the temperature and pressure of air may increase, and the compressor 230 may use this feature to remove moisture from laundry to be dried.

For example, the compressor 230 may identify that the flow passage included in the dryer 200 is clogged if the temperature of the compressor 230 is greater than or equal to the predetermined temperature.

The drum 240 may refer to a drying tank that accommodates laundry to be dried. The drum 240 may be rotated by a driving force generated by a driving motor (not shown). The drum 240 may be disposed inside a tub (not shown) to have a drum opening disposed on one side that corresponds to an inlet for laundry to be dried and a tub opening. Laundry to be dried may be accommodated inside the drum 240 or taken out from the drum 240 by sequentially passing through the inlet for laundry to be dried, the tub opening, and the drum opening.

The drum 240 may perform each operation corresponding to a washing cycle, a rinsing cycle, and/or a dehydration cycle while rotating inside the tub. A plurality of holes may be formed in a cylindrical wall of the drum 240 to allow water stored in the tub (not shown) to flow into the inside of the drum 240 or flow outward from the drum 240.

The sensor 250 may be provided for detecting a weight of laundry to be dried accommodated in the drum. For example, the sensor 250 may be a weight sensor. The sensor 250 may be attached to the drum 240 and measure the weight of laundry to be dried accommodated in the drum 240. However, a method of measuring the weight of laundry to be dried is not limited to using the weight sensor and may also use a Hall sensor.

If the sensor 250 is the Hall sensor, the dryer 200 may operate a driving motor 161 to rotate the drum. The processor 260 may detect a change in current or voltage that occurs if the motor rotates, and estimate a weight loaded on the drum.

For example, the heavier the weight of laundry to be dried contained in the drum, the greater a magnitude of the current or voltage applied to the driving motor. The processor 260 may identify a difference in the current or voltage applied to the driving motor as the drum rotates, and identify a weight corresponding to the difference in the current or voltage as the weight of laundry to be dried accommodated in the drum 240.

The sensor 250 may measure the weight of laundry to be dried disposed inside the drum 240 multiple times while the dryer 200 performs the drying cycle under control of the processor 260. For example, the processor 260 may measure the weight of laundry to be dried before starting the drying cycle, before the dehydration cycle, and during the dehydration cycle.

The processor 260 may include various processing circuitry (see description of processor 130 above) and control the communication interface 210 to transmit the information about the dryer 200. According to an embodiment described above, the processor 260 may transmit the information about the dryer 200, which is simply an example, and may receive information about the error state through the communication interface 210.

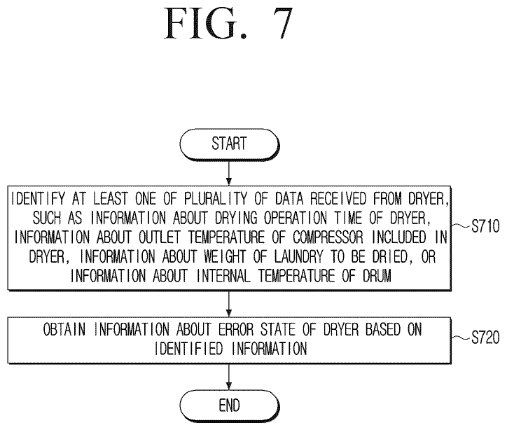

FIG. 7 is a flowchart illustrating an example method of controlling an electronic apparatus according to various embodiments.

The electronic apparatus 100 may identify at least one of the plurality of data received from the dryer, such as the information about the drying operation time of the dryer, the information about the outlet temperature of the compressor included in the dryer, the information about the weight of laundry to be dried, or the information about the internal temperature of the drum (S710).

For example, the electronic apparatus 100 may obtain, from the dryer, not only the information described above, but also information about internal humidity, a current operation, a rotation direction (e.g., forward rotation or reverse rotation) or the set drying mode (e.g., the standard mode or the strong mode).

The electronic apparatus 100 may then obtain the information about the error state of the dryer based on the identified information (S720).

The electronic apparatus 100 may store the identified information, and obtain state information about a usage pattern of the dryer by the user (e.g., information about the amount of laundry to be dried, information about frequently used operation modes) based on the identified information. The electronic apparatus 100 may obtain the information about the error state of the dryer based on the above-described information or the identified information.

The electronic apparatus 100 may transmit the obtained information to the external device. The electronic apparatus 100 may identify the information about the error state of the dryer based on the information transmitted to the external device.

The methods according to various example embodiments may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices 20 (e.g., smartphones). In case of the online distribution, at least a part of the computer program product (e.g., downloadable app) may be at least temporarily stored or temporarily provided in the machine-readable storage medium such as the memory of a manufacturer server, an application store server, or a relay server.

The methods according to the various embodiments of the present disclosure may be implemented by software including an instruction stored in the machine-readable storage medium (for example, a computer-readable storage medium). A machine may be an apparatus that invokes the stored instruction from the storage medium, may be operated based on the invoked instruction, and may include the server device or the electronic apparatus according to the disclosed embodiments.

A machine-readable storage medium may be provided in the form of a non-transitory computer-readable recording medium. Here, the “non-transitory computer-readable recording medium” may refer to a tangible device and indicates that this storage medium does not include a signal (e.g., electromagnetic wave), and this term does not distinguish a case where information is stored semi-permanently in the storage medium and a case where information is temporarily stored in the storage medium from each other. For example, the “non-transitory storage medium” may include a buffer in which information is temporarily stored.

If the instruction is executed by the processor, the processor may directly perform a function corresponding to the instruction or other components may perform the function corresponding to the instruction under a control of the processor. The instruction may include a code provided or executed by a compiler or an interpreter.

Although various example embodiments of the present disclosure are illustrated and described above, the present disclosure is not limited to the various example embodiments, and may be variously modified by those skilled in the art to which the present disclosure pertains without departing from the gist of the present disclosure including the accompanying claims and their equivalents. These modifications should also be understood to fall within the scope and spirit of the present disclosure. It will also be understood than any of the embodiment(s) described herein may be used in connection with any other embodiment(s) described herein.

What is claimed is:

1. An electronic apparatus comprising:
a communication interface comprising communication circuitry;
a memory storing instructions; and
at least one processor comprising processing circuitry,
wherein, at least one processor, individually and/or collectively, is configured to execute the instructions and to cause the electronic apparatus to:
identify at least one of a plurality of data received from a dryer, including information about a drying operation time of the dryer, information about an outlet temperature of a compressor included in the dryer, information about a weight of laundry to be dried or information about an internal temperature of a drum, and
obtain information about an error state of the dryer based on the identified information.

2. The device as claimed in claim 1, wherein, at least one processor, individually and/or collectively, is configured to cause the electronic apparatus to identify that an abnormality occurs in a humidity sensor included in the dryer based on the drying operation time of the dryer being less than a specified time.

3. The device as claimed in claim 2, wherein, at least one processor, individually and/or collectively, is configured to cause the electronic apparatus to identify that the abnormality occurs in the humidity sensor included in the dryer based on the drying operation time of the dryer being greater than or equal to the specified time, and the internal temperature of the drum measured after a drying operation of the dryer is completed being greater than or equal to a specified temperature.

4. The device as claimed in claim 3, wherein, at least one processor, individually and/or collectively, is configured to cause the electronic apparatus to identify that an amount of laundry to be dried is less than a specified weight based on the drying operation time of the dryer being less than the specified time, and the internal temperature of the drum included in the dryer measured after the drying operation of the dryer is completed being less than the specified temperature.

5. The device as claimed in claim 4, wherein, at least one processor, individually and/or collectively, is configured to cause the electronic apparatus to include information indicating that the amount of laundry to be dried is required to be filled to the specified weight or more.

6. The device as claimed in claim 1, wherein, at least one processor, individually and/or collectively, is configured to cause the electronic apparatus to identify that a flow passage included in the dryer is clogged based on a ratio of an actual drying operation time of the dryer to a predicted drying operation time of the dryer being greater than or equal to a specified value, and the temperature of the compressor included in the dryer being greater than or equal to a specified temperature.

7. The device as claimed in claim 6, wherein, at least one processor, individually and/or collectively, is configured to cause the electronic apparatus to identify that an abnormality occurs in a sensor included in the dryer based on the ratio of the actual drying operation time of the dryer to the predicted drying operation time of the dryer being greater than or equal to the specified value, and a result value obtained by subtracting an actual weight value from a weight value obtained using the sensor included in the dryer being greater than or equal to a specified value.

8. The device as claimed in claim 1, wherein, at least one processor, individually and/or collectively, is configured to cause the electronic apparatus to transmit the information about the error state of the dryer to an external device.

9. A method of controlling an electronic apparatus, the method comprising:
identifying at least one of a plurality of data received from a dryer, including information about a drying operation time of the dryer, information about an outlet temperature of a compressor included in the dryer, information about a weight of laundry to be dried or information about an internal temperature of a drum; and
obtaining information about an error state of the dryer based on the identified information.

10. The method as claimed in claim 9, further comprising identifying that an abnormality occurs in a humidity sensor included in the dryer in response to the drying operation time of the dryer being less than a specified time.

11. The method as claimed in claim 10, further comprising identifying that the abnormality occurs in the humidity sensor included in the dryer in response to the drying operation time of the dryer being greater than or equal to the specified time, and the internal temperature of the drum measured after a drying operation of the dryer is completed being greater than or equal to a specified temperature.

12. The method as claimed in claim 11, further comprising identifying that an amount of laundry to be dried is less than a specified weight in response to the drying operation time of the dryer being less than the specified time, and the internal temperature of the drum included in the dryer measured after the drying operation of the dryer is completed being less than the specified temperature.

13. The method as claimed in claim 12, further comprising including information indicating that the amount of laundry to be dried is required to be filled to the specified weight or more.

14. The method as claimed in claim 9, further comprising identifying that a flow passage included in the dryer is clogged in response to a ratio of an actual drying operation time of the dryer to a predicted drying operation time of the dryer being greater than or equal to a specified value, and the temperature of the compressor included in the dryer being greater than or equal to a specified temperature.

15. The method as claimed in claim 14, further comprising identifying that an abnormality occurs in a sensor included in the dryer in response to the ratio of the actual drying operation time of the dryer to the predicted drying operation time of the dryer being greater than or equal to the specified value, and a result value obtained by subtracting an actual weight value from a weight value obtained using the sensor included in the dryer being greater than or equal to a specified value.
